(19) United States
(12) Patent Application Publication
(10) Pub. No.: US 2007/0006816 A1
(43) Pub. Date: Jan. 11, 2007

(54) Multiple function animal training system with extendable ramp

(76) Inventor: Dan Dietz, Houston, TX (US)

Correspondence Address: TUMEY, L.L.P., P.O. BOX 22188, HOUSTON, TX, 77227-2188, US

(21) Appl. No.: 11/481,629

(22) Filed: Jul. 6, 2006

Related U.S. Application Data
(63) Continuation-in-part of application No. 11/437,559, filed on May 19, 2006.
Application No. 11/437,559 is a continuation-in-part of application No. 11/344,655, filed on Jan. 30, 2006.
Application No. 11/344,655 is a continuation-in-part of application No. 11/287,716, filed on Nov. 28, 2005.
Application No. 11/287,716 is a continuation-in-part of application No. 11/121,797, filed on May 4, 2005.

(51) Int. Cl. A01K 1/03

(52) U.S. Cl. 119/482

(57) ABSTRACT

A multiple function animal furniture structure and method for providing housing to an animal are disclosed. In an embodiment, the multiple function animal furniture structure comprises a plurality of sides. The plurality of sides comprises a top side, a bottom side, a back side, a front side, and at least one side wall. The front side comprises a front side opening. In addition, at least one of the sides comprises an opening comprising a character shape. The multiple function animal furniture structure further comprises a detachable and extendable ramp member, wherein the ramp member provides a surface suitable for an animal to climb to the top side.

### CROSS-REFERENCE TO RELATED APPLICATIONS

This application is a continuation-in-part of U.S. application Ser. No. 11/437,559 filed on May 19, 2006, which is a continuation-in-part of U.S. application Ser. No. 11/344,655 filed on Jan. 30, 2006, which is a continuation-in-part of U.S. application Ser. No. 11/287,716 filed on Nov. 28, 2005, which is a continuation-in-part of U.S. application Ser. No. 11/121,797 filed on May 4, 2005, which are each incorporated by reference herein in their entirety.

### STATEMENT REGARDING FEDERALLY SPONSORED RESEARCH OR DEVELOPMENT

Not applicable.

### BACKGROUND OF THE INVENTION

1. Field of the Invention

This invention relates to furniture for an animal and in particular to furniture that has multiple configurations and may function in multiple ways to accommodate various desires of the animal at any stage of growth. More particularly, this invention describes a detachable and extendable ramp member attached to the furniture structure. The extendable ramp member allows the owner to vary the ramp length and thereby decrease the angle of inclination if desired.

2. Background of the Invention

For many people, pet animals are members of the family. Some of these pets live inside the home with the owner and have many accessories designed especially for the animal. As with the typical dog houses, some of the furnishings provide a place for the animal to dwell as well as provide a storage place for the toys of the animal. One conventional piece of animal furniture is a bed. There have been many types of animal beds. These beds are available in various designs. Some of the designs include beds shaped as different types of animals. Many beds in the form of animal designs are made of a cushion material to facilitate animal comfort.

One animal bed is disclosed in U.S. Pat. No. 5,662,065 and describes an animal bed that includes an annular bed frame defining an interior chamber. A perforated top wall is supported at its periphery by the bed frame to receive and support the animal above the chamber. The perforated top wall is composed of a non-woven fabric material to provide a hammock-like suspension for the animal and to permit small insects to fall through the top wall. The chamber is dimensioned to provide a space below the top wall sufficient to inhibit the insects from traveling upwardly through the top wall. An insect exterminating composition contained within the chamber receives the falling insects and destroys them.

U.S. Pat. No. d288,970 describes a combined animal bed and housing unit. This design has a bed mat resting on a storage unit. The bed also has a canopy covering the mat. The animal may rest on the mat and may be covered by the canopy.

Although the animal bed is a common piece of furniture for the inside pet, animals do more than just sleep. For instance, cats typically have a litter box for waste. Many pets and owners have a system by which the pet is let out of the house on a periodic basis to relieve themselves. Pets also have toys with which they play. One particular thing some pets like to do is to climb up on the owner's bed. The climbing may be necessary because many pets may not jump high enough to reach the surface of the bed in one jump. The climbing process may result in the pet pulling and sometimes tearing the bed linen. Moreover, as the pet grows, the need may arise to replace a piece of animal furniture with a different type of furniture or a larger size of the same furniture. With all of the different types of animal furniture that are available to accommodate the many needs of the pet and pet owner, there remains a need for a multiple function piece of animal furniture.

For some younger and some older animals, climbing onto the furniture piece may be difficult. With the assistance of a ramp, the climb may be easier. However, in some instances, the inclination angle of the ramp on the furniture piece may be too steep for the animal to easily climb onto the furniture piece. Therefore, a need remains for a means to adjust the inclination angle of a ramp member such that an animal may easily climb the ramp member to the top of the furniture piece.

### BRIEF SUMMARY OF SOME OF THE PREFERRED EMBODIMENTS

These and other needs in the art are addressed in an embodiment by a multiple function animal furniture structure. The multiple function animal furniture structure comprises a plurality of sides. The plurality of sides comprises a top side, a bottom side, a back side, a front side, and at least one side wall. In addition, the front side comprises a front side opening. The at least one of the sides comprises an opening comprising a character shape. Moreover, the multiple function animal furniture structure comprises a detachable and extendable ramp member, wherein the ramp member provides a surface suitable for an animal to climb to the top side.

In another embodiment, these and other needs in the art are addressed by a method for providing housing to an animal. The method comprises providing a structure comprising a plurality of sides, wherein the plurality of sides comprises a top side, a bottom side, a back side, a front side, and at least one side wall. The method further comprises providing an opening in at least one of the plurality of sides, wherein the opening comprises a character shape. In addition, the method comprises providing a detachable and extendable ramp member, wherein the ramp member provides a surface suitable for an animal to climb to the top side.

The present invention provides a multi-purpose furniture piece and system that may be used for an animal throughout the life of the animal. For small animals such as puppies, this furniture system may be used as a dwelling in which the owner may train the animal to behave in a desired manner. The animal training may include house training. Animal toys may also be stored in the animal living space as well. A removable barrier such as a grate or plastic ventilated sheet may cover a front opening to prevent movement of the animal in and out of the furniture piece. Animals may use a detachable ramp member to climb to the top of the furniture piece. For larger or older animals, the furniture piece may serve as a bed or as a means to help the animal get into the bed of the owner. The furniture piece may form a bed for animals of all ages. The bed may be positioned adjacent an owner's bed.

The ramp member is also extendable. The owner may vary the length of the ramp such that the angle of inclination of the ramp against the animal furniture piece may vary. The ability to vary the climbing angle sometimes may be desirable to assist animals that have difficulty climbing a ramp positioned at a steeper angle. The extendable ramp structure may be of various designs and may comprise two or more sections. The sections are slidably attached to each other such that a lower section moves relative to an upper section to vary the length of the ramp. The movement of the lower section may be in discrete intervals or may be designed to vary the ramp length to any desirable length.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a front, top and side view of the multiple function animal furniture piece;

FIG. 2 illustrates a view of the multiple function animal furniture piece with the top extended up to open the furniture piece;

FIG. 3 illustrates a view of the multiple function animal furniture piece with a ramp member extended from the furniture piece;

FIG. 4 illustrates a view of the multiple function animal furniture piece with a ramp member extended from the furniture piece such that the angle of inclination is decreased;

FIG. 5 illustrates a side view of a configuration of an extendable ramp;

FIG. 6a illustrates a side view of one embodiment of an extendable ramp having a rotatable lower section;

FIG. 6b illustrates a top view of the extendable ramp having a rotatable lower section;

FIG. 7a illustrates a top view of an alternate embodiment of an extendable ramp;

FIG. 7b illustrates a side view of the extendable ramp embodiment of FIG. 7a;

FIG. 8 illustrates a bracket designed to hold a lower section and provide a guide for movement of the lower section in relation to the upper section of the extendable ramp;

FIG. 8a illustrates extrusions in the lower section of the extendable ramp;

FIG. 8b illustrates a recess in the bracket for engaging the extrusions from the lower section of the extendable ramp;

FIG. 9 illustrates a side view of an alternate embodiment having multiple sections of the ramp;

FIG. 10 illustrates a view of the backside of the furniture piece showing the ramp in a stored position; and

FIG. 11 illustrates a view of the interior top of the furniture piece showing the grate in a stored position.

### DETAILED DESCRIPTION OF THE PREFERRED EMBODIMENTS

The multiple function animal furniture piece provides an animal owner with a system that may be used for an animal throughout the life of the animal. The multiple function animal furniture piece may serve as a training cage to help train small animals such as puppies for living indoors. A detachable mat on the floor of the multiple function animal furniture piece provides for ease in cleaning animal waste. A removable front cover such as a grill or grate may serve to restrict undesired movement of the animal in and out of the multiple function animal furniture piece. The multiple function animal furniture piece may also have another function as a storage structure. As will be discussed, the multiple function animal furniture piece has an attachable ramp member for use by an animal to climb to the top of the furniture structure. This ramp is especially useful for smaller animals and older animals. The ramp may be stored inside the multiple function animal furniture piece when the ramp is not in use. This multiple function animal furniture piece is portable and may be positioned adjacent the owner's bed. In this arrangement, the animal may easily move from the multiple function animal furniture piece to the owner's bed. Further, the owner may easily sit on the top of the multiple function animal furniture piece. When an animal dies, the multiple function animal furniture piece may be converted into a container (e.g., coffin) for burying the deceased animal.

FIG. 1 shows a general design of the multiple function animal furniture piece 5. Other configurations such as those described in U.S. patent application Ser. No. 11/121797 and U.S. patent application Ser. No. 11/287,716 to the same inventor may be implemented to achieve the same results as the design described in FIG. 1. As shown, multiple function animal furniture piece 5 has a top 10, open front side 12, a back side 14, and multiple side walls 16 and 18. The number of sides may vary with the particular design shape. Multiple function animal furniture piece 5 may also contain a floor 20. The front side 12 has an opening 22, which covers a large portion of the front side 12. Without limitation, this large opening 22 allows for animals to easily enter multiple function animal furniture piece 5. The opening 22 also allows for easy insertion of toys, food, water, and the like into multiple function animal furniture piece 5. In addition, smaller openings 24 and 26 may be disposed in side walls 16, 18. These openings 24, 26 improve ventilation in multiple function animal furniture piece 5. The front side 12 also has a lip 28 that extends up from the base. Without limitation, this lip 28 serves to prevent toys such as balls from accidentally rolling out of multiple function animal piece 5. In addition, a lip section (not illustrated) may also be attached to the top 10 to serve as, without limitation, restraining means to stabilize a cushion disposed on top 10 and keep the cushion stationary when an animal is disposed on the cushion.

It is to be understood that side walls 16, 18 may have one or more than one opening, respectively, and that side walls 16, 18 are shown in FIG. 1 with each side wall 16, 18 having one opening each (openings 24, 26) for illustration purposes only. It is also to be understood that back side 14 may have no such openings or one or more such openings. In an alternative embodiment, one or more of the sides may have no such openings. Openings in side walls 16, 18 and back side 14 may have any shape, configuration, and size suitable for allowing ventilation and visibility into and out of multiple function animal furniture piece 5. For instance, such openings may have the shape of characters such as animals, cartoon figures, toys, lettering, numbering, symbols, and the like. Without limitation, examples of animal shapes include dogs, cats, and the like. In addition, without limitation, examples of cartoon figures include MICKEY MOUSE (which is a mark owned by Disney Enterprises, Inc.), SUPERMAN (which is a mark owned by DC Comics Warner Communications Inc.), and the like. Examples of toys include, without limitation, trucks, cars, airplanes, and the like. The character shape openings may be applied to the sides by any suitable process such as by a cutting apparatus, press, or the like.

Multiple function animal furniture piece 5 may be composed of any material suitable for the desired use of multiple function animal furniture piece 5. For instance, multiple function animal furniture piece 5 may be composed of wood, mesh, wire, plastic, metal, and the like. In such an embodiment, back side 14 and/or multiple side walls 16 and 18 may comprise wire, mesh, netting, weaving, and the like, preferably wire or mesh, and more preferably wire or wire-like material. Moreover, back side 14 and/or multiple side walls 16 and 18 may be composed of any porous material suitable for use as a side in an animal cage (e.g., porous metal or plastic siding). In an embodiment, back side 14 and/or multiple side walls 16 and 18 are composed of plastic, wood, metal, or the like wire or wire-like material. One or more of multiple side walls 16 and 18 (preferably both side walls 16, 18) may be composed of such materials. In an embodiment (not illustrated), an outer covering may be disposed on the outside and/or inside surface of one or more of any side (e.g., front side 12, back side 14, side walls 16 and 18, top 10, floor 20) preferably an outer covering is disposed on the outside surface. In some embodiments, an outer covering is disposed on the outside surface of multiple side walls 16 and 18, back side 14, and/or top 10. The outer covering may cover any desired portion of a side. In addition, the outer covering may comprise any suitable covering for use with animals. For instance, the outer covering may be composed of natural or synthetic woods, veneers, vinyl, wicker, plastic, ceramic, and the like. In an embodiment, top 10 and/or front side 12 may also be composed of such plurality of openings and/or may also include such an outer covering. In alternative embodiments, at least one side and/or wall of multiple function animal furniture piece 5 comprises a substantially solid material.

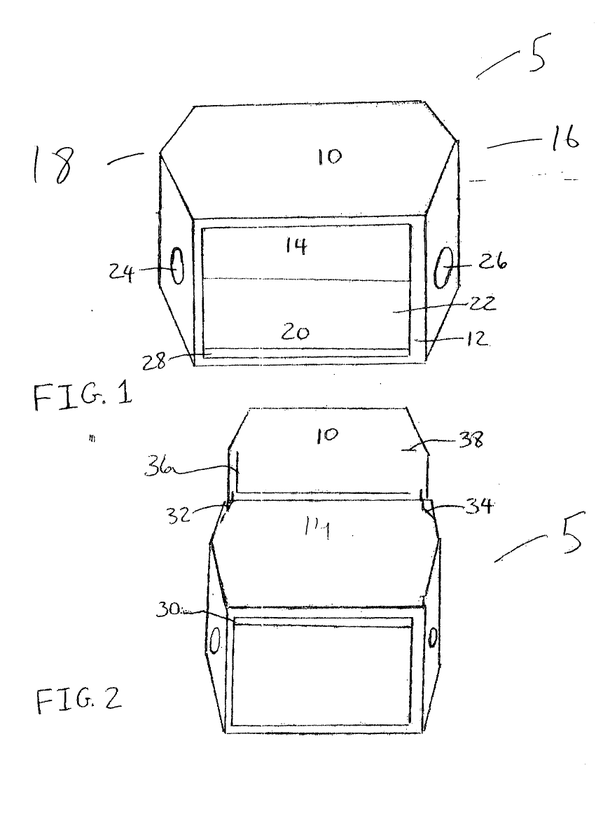

FIG. 2 shows multiple function animal furniture piece 5 with the top 10 extended in an upward position, which thereby opens up multiple function animal furniture piece 5. All or a portion of top 10 may be extended in any such position. As shown, a bar 30 extends across the front side 12 and may serve as a rest bar for the top 10. Hinges 32 and 34 attach the top 10 to the back side 14 and allow the top 10 to open and close as desired. It is to be understood that any number and type of hinge may be used. Attached to the inside surface of the top 10 is a rack member 36 for holding a ramp member when the ramp member is not in use. The rack member 36 has an L-shape that fits with the shape of a rectangular ramp member. This L-shaped rack may be a groove with a generally u-shape in which the ramp member is placed. When the ramp member is placed in the rack member 36, a latch 38 secures the ramp in the rack member 36.

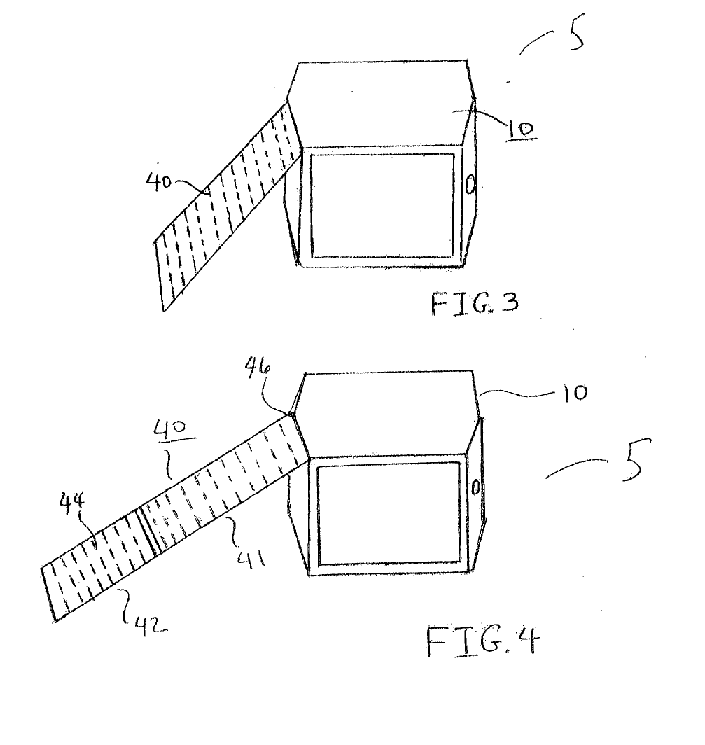

FIG. 3 shows a configuration of multiple function animal furniture piece 5 with a detachable ramp 40 engaged at one side. In this configuration, an animal may climb to the top 10 without climbing up on a bed or other piece of furniture. Depending on the height of multiple function animal furniture piece 5, the length of the ramp 40 may vary such that the inclination angle formed by the engagement of the ramp 40 to multiple function animal furniture piece 5 is not too steep for the animal to safely climb.

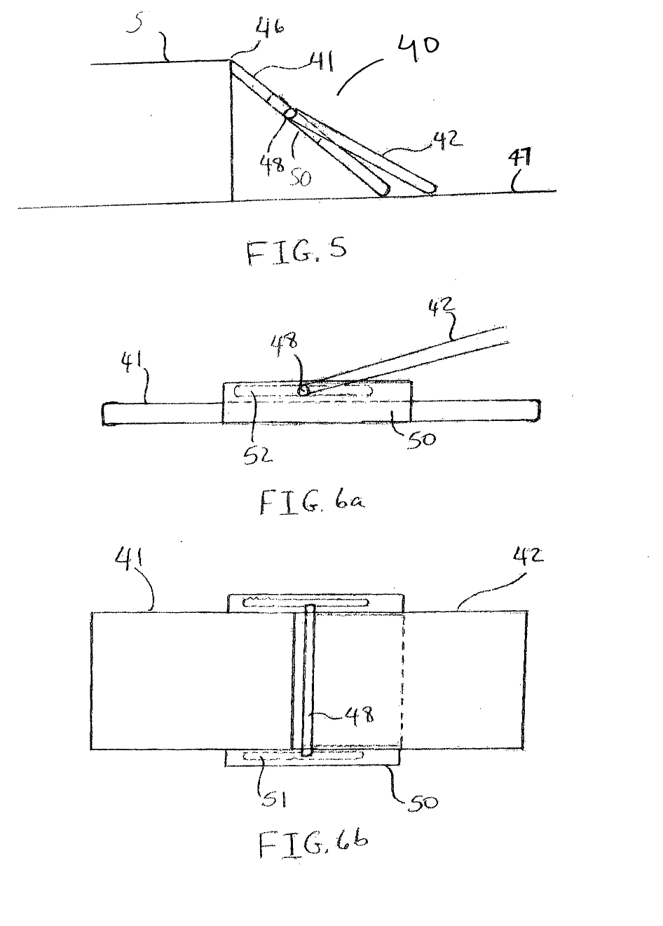

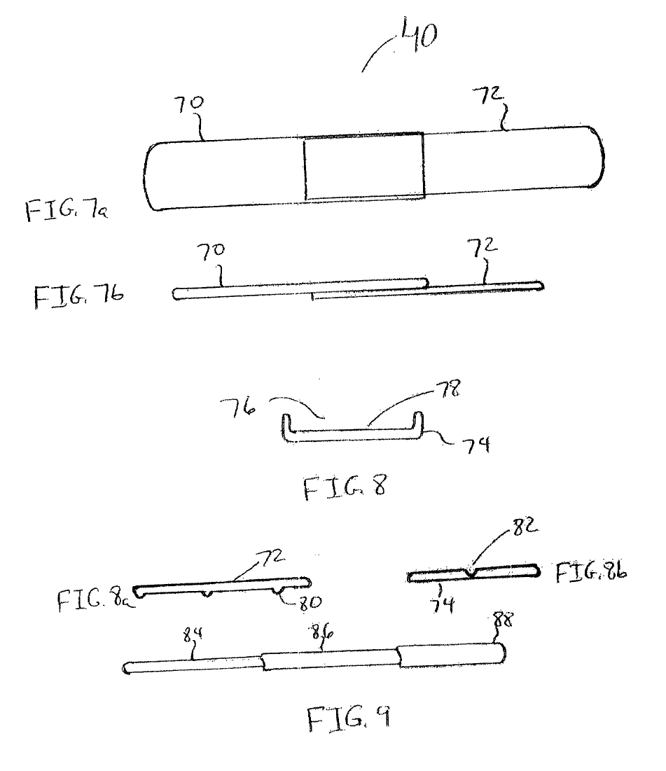

FIG. 4 shows a configuration of the multiple function animal furniture piece 5 having the extendable ramp 40. The ramp 40 may comprise two sections. The upper section 41 may have a length similar to the length of the ramp 40 shown in FIG. 3. This upper section 41 has sufficient length such that it may solely assist some animals climbing to the top 10. Attached to this front side of each section may be a fiber-type material 44 such as a cloth or carpet material. This fiber-type material 44 increases the friction of the ramp 40 such that an animal may have sufficient traction as the animal climbs the ramp 40 to the top 10. The ramp 40 contains a lip 46 in the upper section 41 that engages the edge of the top 10 securing the ramp 40 to the multiple function animal furniture piece 5.

FIG. 5 shows a general configuration for an extendable ramp 40. The upper section 41 attaches to the multiple function animal furniture piece 5 using the lip mechanism 46. The top end of the lower section 42 may comprise a bar 48. The bar 48 slidably engages the upper section 41. A translation section 50 facilitates the engagement and attachment of the upper and lower sections 41, 42 of the extendable ramp 40. The lower section 42 extends to the ground 47 or other support on which multiple function animal furniture piece 5 is disposed.

FIGS. 6a and 6b show an embodiment of the extendable ramp 40 that is related to the extendable ramp 40 shown in FIG. 5. The two ramp sections 41 and 42 are slidably attached by the engagement of the bar 48 of the lower section 42 with the translation area 50 of the upper section 41. The bar 48 fits into a groove 52 in the translation area 50. The bar 48 is able to move linearly with the groove 52. The translational movement of the lower section 42 with regard to the upper section 41 may vary the length of the two-section ramp 40. The lower section 42 may be linearly moveable in relation to the upper section 41.

FIGS. 7a and 7b show an alternate embodiment of the extendable ramp 40. In this embodiment, an upper section 70 engages a lower section 72 to form the extendable ramp 40. The linear movement of the sections 70, 72 may vary the length of the ramp 40. In this embodiment, the upper section 70 may also have a means to engage the multiple function animal furniture piece 5 such as the previously mentioned lip member. In addition, the edge of the upper section 70 that engages the multiple function animal furniture piece 5 may be designed such that there is some minimal sway on the ramp 40, which may allow for a rotational movement of the ramp 40 without detaching the ramp 40 from the multiple function animal furniture piece 5.

FIG. 8 shows a bracket 74 that may be attached to the under side of the upper section 70. The bracket 74 is designed such that channel 76 creates a clearance between the upper section 70 and the bracket surface 78. The lower section 72 may engage the upper section 70 through channel 76. In this embodiment, FIGS. 8a and 8b show a design for the engagement of the lower section 72 with the bracket 74. As shown, in FIG. 8a, the bottom surface of the lower section 72 may have extrusions 80 that may extend downward. FIG. 8b shows recesses 82 in the surface 78 of the bracket 74. These recesses 82 have the same shape as the extrusions 80 to facilitate the engagement of the lower section 72 of the ramp 40 with the bracket 74. The bracket 74 design may be a design that extends a portion of the length of the lower section of the ramp 40 and may serve as a translation and engagement area between the upper and lower sections of the ramp in a manner similar to the previously described translation area 50.

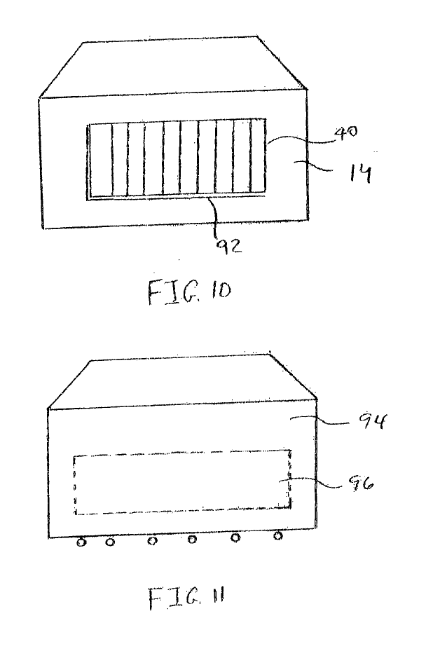

FIG. 9 shows another embodiment of the extendable ramp 40. The configuration of this embodiment comprises multiple sections that may extend and retract as desired. As shown, the multiple sections 84, 86 and 88 have slightly different areas. Without limitation, this configuration is similar to a telescope design. For instance, one section may fit inside the adjacent section.

FIG. 10 is a view of the back side 14 of multiple function animal furniture piece 5 showing the ramp 40 in a stored position. In this configuration, when the ramp 40 is not in use (e.g., attached to the multiple function animal furniture piece 5), it may be stored on the back side 14. In an embodiment, ramp 40 may be retracted to a minimum length and placed in a rack 92 affixed to back side 14.

FIG. 11 is a view of the interior top 94 of the multiple function animal furniture piece 5 showing the grate 96 in a stored position. In this configuration, sets of instructions may be attached to this interior 94. The design of the grate 96 may enable the owner to read the instructions through the grate 96.

As mentioned, the structure and system of the multiple function animal furniture piece 5 provides the owner of an animal with the versatile means for providing care for the animal. This structure and system may accommodate activities for animals of all ages and sizes. The structure serves as both a dwelling for small animals as well as a training cage to teach certain behaviors. The internal storage capacity makes this structure useful for any animal that has toys. The ability to store the detachable components of the system within the structure itself makes this system easy to manage. The portability of the structure enables the owner to position it at any location. As mentioned, owners may use it as a bed for the animal or as a means for the animal to climb into the owner's bed. The attachable ramp also may make it easy for animals of all ages and sizes to climb the ramp to the top side of the structure. At the animal's death, the structure may serve as a container coffin in which to bury the animal.

As mentioned, the configurations for attaching the multiple sections of the ramp may vary. Described herein are only examples of the various configurations one may mechanically design an extendable ramp for use as described herein.

Although the present invention and its advantages have been described in detail, it should be understood that various changes, substitutions and alterations may be made herein without departing from the spirit and scope of the invention as defined by the appended claims.

What is claimed is:

1. A multiple function animal furniture structure comprising:
a plurality of sides comprising a top side, a bottom side, a back side, a front side, and at least one side wall, wherein the front side comprises a front side opening, and wherein at least one of the sides comprises an opening comprising a character shape; and
a detachable and extendable ramp member, wherein the ramp member provides a surface suitable for an animal to climb to the top side.

2. The multiple function animal furniture structure of claim 1, wherein the at least one of the sides comprises more than one opening.

3. The multiple function animal furniture structure of claim 1, wherein the character shape comprises an animal shape, a cartoon figure shape, a toy shape, a letter shape, a number shape, or a symbol shape.

4. The multiple function animal furniture structure of claim 1, further comprising a lip element.

5. The multiple function animal furniture structure of claim 1, wherein the ramp member comprises an upper ramp section and a lower ramp section, and wherein the upper and lower ramp sections are slidably attached to allow the lower section to linearly move in relation to the upper section.

6. The multiple function animal furniture structure of claim 5, wherein the upper and lower ramp sections are engaged in a translation area, and wherein the translation area provides an area along the upper ramp section lengthwise for which the lower ramp section moves in relation to the upper ramp section.

7. The multiple function animal furniture structure of claim 6, further comprising a bracket attached to the upper ramp section such that the bracket has a surface and extends below the upper ramp section and forms a clearance between the upper ramp section and the bracket.

8. The multiple function animal furniture structure of claim 7, wherein the bracket engages the lower ramp section such that the lower ramp section is slidably attached to the upper ramp section.

9. The multiple function animal furniture structure of claim 8, wherein the bracket has recesses in the bracket surface to engage extrusions that extend from the lower ramp section.

10. The multiple function animal furniture structure of claim 5, wherein a fiber material is attached to the ramp member.

11. The multiple function animal furniture structure of claim 1, further comprising a rack member attached to the back side.

12. The multiple function animal furniture structure of claim 11, further comprising a second rack member.

13. The multiple function animal furniture structure of claim 1, wherein the upper section comprises a lip member, and wherein the lip member engages the top side.

14. The multiple function animal furniture structure of claim 1, wherein the plurality of sides comprise wire, mesh, netting, weaving, or combinations thereof.

15. The multiple function animal furniture structure of claim 1, wherein the plurality of sides comprise wire or wire-like material.

16. The multiple function animal furniture structure of claim 1, further comprising an outer covering disposed on an outer surface of the plurality of sides.

17. A method for providing housing to an animal, comprising:
(A) providing a structure comprising a plurality of sides, wherein the plurality of sides comprises a top side, a bottom side, a back side, a front side, and at least one side wall;
(B) providing an opening in at least one of the plurality of sides, wherein the opening comprises a character shape; and
(C) providing a detachable and extendable ramp member, wherein the ramp member provides a surface suitable for an animal to climb to the top side.

18. The method of claim 17, wherein the at least one of the sides comprises more than one opening.

19. The method of claim 17, wherein the character shape comprises an animal shape, a cartoon figure shape, a toy shape, a letter shape, a number shape, or a symbol shape.

20. The method of claim 17, wherein the ramp member further comprises an upper ramp section and a lower ramp section, and wherein the upper and lower ramp sections are slidably attached to allow the lower section to linearly move in relation to the upper section.
